(19) United States
(12) Patent Application Publication
(10) Pub. No.: US 2005/0183086 A1
(43) Pub. Date: Aug. 18, 2005

(54) Method for managing task and information processing apparatus for managing task

(75) Inventors: Yasuhiko Abe, Niiza-shi (JP); Katsunori Takami, Hamura-shi (JP); Akira Imai, Akishima-shi (JP)

Correspondence Address: BANNER & WITCOFF, LTD., ATTORNEYS FOR RESERVE;CLIENT NO. 4, 1001 G STREET, N.W., 11TH FLOOR, WASHINGTON, DC, 20001-4597, US

(73) Assignee: Kabushiki Kaisha Toshiba, Minato-ku (JP)

(21) Appl. No.: 10/944,764

(22) Filed: Sep. 21, 2004

(30) Foreign Application Priority Data
Feb. 13, 2004 (JP) 2004-037214

(51) Int. Cl. G06F 9/46

(52) U.S. Cl. 718/100

(57) ABSTRACT

According to a method for managing a task, attributions of first to nth function task groups for executing one function respectively are stored in an attribution storage unit of the function task group, and according to the attribution stored in the attribution storage unit of the function task group, a function task group managing unit assigns a resource to the task belonging to the first to nth function task groups and executes the operation with related to an interruption caused during execution of the task belonging to the first to nth function task groups.

### CROSS-REFERENCE TO RELATED APPLICATIONS

This application is based upon and claims the benefit of priority from prior Japanese Patent Application No. 2004-037214, filed Feb. 13, 2004, the entire contents of which are incorporated herein by reference.

### BACKGROUND OF THE INVENTION

1. Field of the Invention

The present invention relates to a method for managing a task and an information processing apparatus for managing a task, and particularly, the present invention relates to a method for managing tasks that are divided into plural groups and an information processing apparatus for managing the tasks.

2. Description of the Related Art

In an information processing apparatus, it is known that one function is defined for the minimum unit that is referred to as a task, and various functions are processed due to a combination of these tasks. According to the combination of the tasks, priorities of the tasks are appropriately managed, and in addition, by appropriately assigning resources to the tasks and appropriately processing an interruption during execution of the task, the information processing apparatus can execute a desired function. In addition, in order to manage the task, it is necessary to grasp the state of the task and a technology to grasp the state of the task by storing the information representing the state of the task, for example, the information referred to as a task control block is known. With respect to such a technology, for example, please refer to “Operating System”, first edition, January 1972, pp. 169-170, supervised by Hiroshi OGIWARA, written by Mamoru MAEKAWA, Nippon-Hyoron-Sha Co., Ltd. However, according to the method disclosed in this document, in the case of executing one function by a plurality of tasks, all attributions that are peculiar to this function, for example, a priority of this function is necessarily stored as the attributions of the above-described plural task, and this involves a problem that the task management becomes complicated.

### BRIEF SUMMARY OF THE INVENTION

An object of the present invention is to provide a method for managing a task to store a function that is peculiar to a function for each function and an information processing apparatus for managing a task.

According to the method for managing a task of the present invention, a main task is activated, and an attribution of a task group composed of the main task and subordinate tasks not less than 0 that are activated by the main task is stored. When the tasks belonging to the task group are during operation, the tasks are controlled according to the stored attributions of the task group.

According to one aspect of the present invention, there is provided a method for managing a task when a desirable function is executed by one or plural tasks, the method comprising: configuring a task group made by one main task and one or more subordinate tasks instructed to be activated by the main task when a plurality of tasks is activated for executing a desirable function; assigning priority information to the task or the main task activated according to the function instructed to be executed; setting an authority of execution to the task or the main task to which the highest priority information is assigned; and setting the authority of execution to the task or the main task to which a second highest priority information is assigned if the task or the main task to which the authority of execution is set is terminated.

According to another aspect of the present invention, there is provided an information processing apparatus, comprising: a task attribution storage unit which is activated to execute a desired function and stores an attribution including priority information assigned to a task group made of a main task and a subordinate task activated by the main task; and a task control unit which sets an authorization of execution to a task group to which the highest priority information is assigned with reference to the priority information stored in the task attribution storage unit.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile communication terminal according to an embodiment of the present invention;

FIG. 2 is a table showing an attribute of a function task group that is stored in an attribution storage unit shown in FIG. 1;

FIG. 3 is a block diagram showing a configuration of the function task group shown in FIG. 1;

FIG. 4 is a table showing an attribution of a subordinate task that is included in the function task group shown in FIG. 1;

FIG. 5 is a flowchart showing the operation when a key input resource is generated in a managing unit for managing the function task group shown in FIG. 1;

FIG. 6 is a flowchart showing the operation of a back light control in the managing unit for managing the function task group shown in FIG. 1; and

FIG. 7 is a flowchart showing the operation when an incoming interruption is caused in the managing unit for managing the function task group shown in FIG. 1.

### DETAILED DESCRIPTION OF THE INVENTION

With reference to the drawings, a method for managing a task and an information processing apparatus for managing a task according to an embodiment of the present invention will be described below.

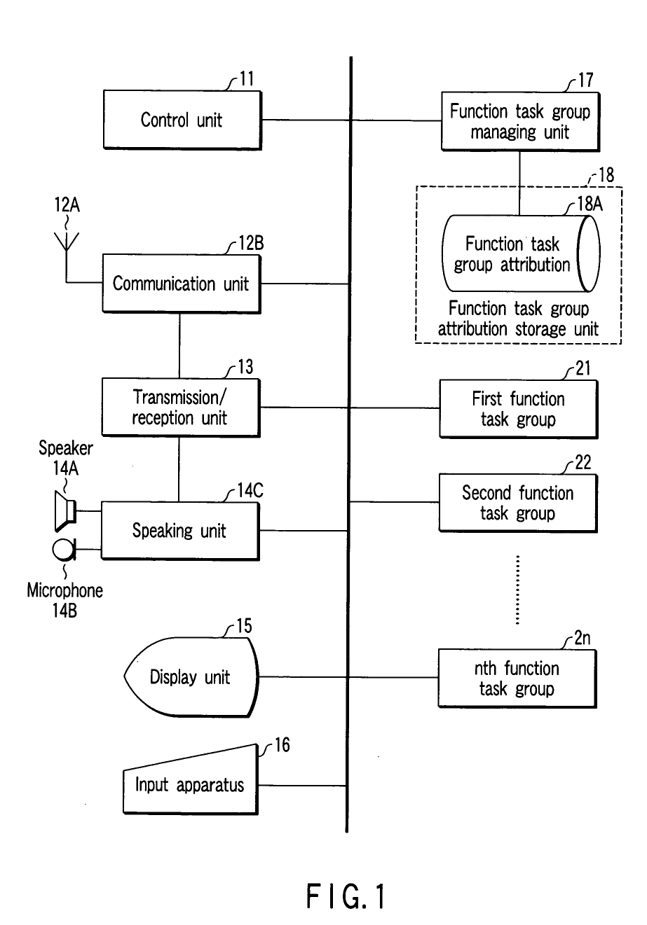

FIG. 1 is a block diagram showing a mobile communication terminal as an information processing apparatus, to which a method for managing a task according to an embodiment of the present invention is applied.

As same as a normal terminal, the mobile communication terminal shown in FIG. 1 includes a control unit 11 for controlling the entire apparatus, an antenna 12A for transmitting and receiving an electric wave between a base station (not shown) and this terminal, a communication unit 12B, a transmission/reception unit 13, a speaker 14A, a microphone 14B, a speaking unit 14C, a display unit 15, and an input apparatus 16. In addition, the mobile communication terminal includes a first function task group 21 for executing this first function, a second function task group 22 for executing this second function, a nth function task group 2n for executing this nth function, a managing unit 17 for managing these function task groups, and a storage unit 18 for storing the attributions of these function task groups 21, . . . , and 2n. This first to nth functions may include a function to wait for sending and receiving, a function to transmit and receive an e-mail, a function to use a Web browser, a function to play an interactive game, and a function to cope with waste of a secondary battery of a terminal or the like.

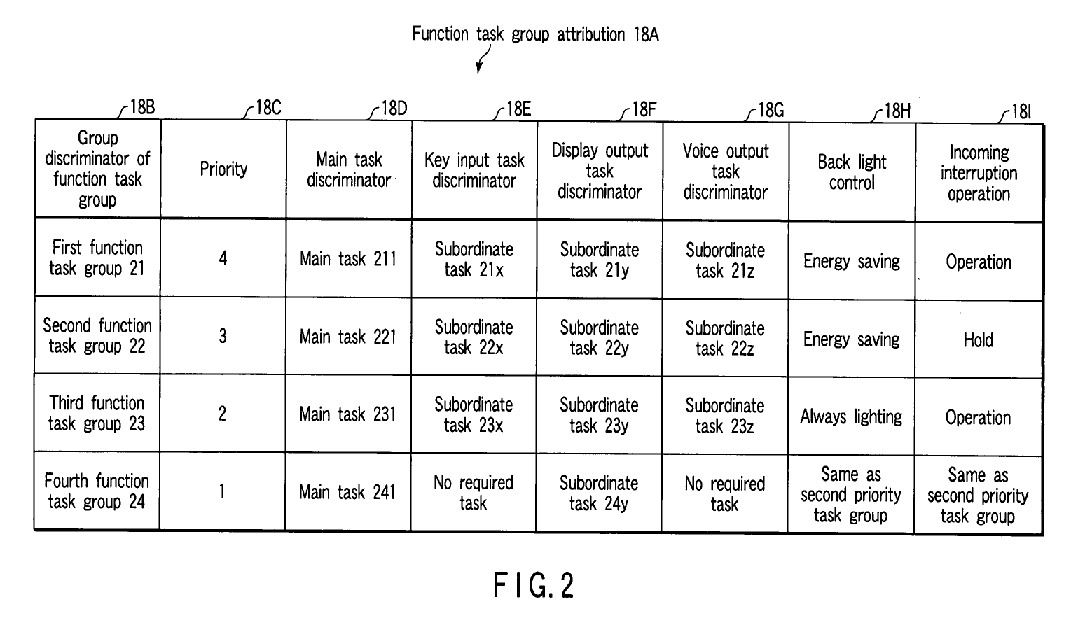

The storage unit 18 stores an attribution 18A of the function task groups 21, . . . , and 2n in a table as shown in FIG. 2. As shown in FIG. 2, as described later respectively, the attribution 18A of the function task groups 21, . . . , and 2n to be stored in the table of the storage unit 18 may include a group discriminator 18B of the function task groups 21, and 2n, a priority 18C, a main task discriminator 18D, a key input task discriminator 18E, a display output task discriminator 18F, a voice output task discriminator 18G, a back light control 18H, and an incoming interruption operation 18I as a plurality of items.

As being obvious from FIG. 2, in this attribution table, the attributions of the function task groups 21, . . . , and 2n to be discriminated respectively by the group discriminator 18B of the function task groups 21, . . . , and 2n are described. In the item of the priority 18C, a priority of one function task group to be specified by the group discriminator 18B, for example, a priority of a right to demand assignment of a resource is described by a series of natural numbers. In the item of the priority 18C, “1” represents the highest priority, and a larger natural number represents a lower priority. In the item of the main task discriminator 18D, the main task discriminators of respective function task groups 21, . . . , and 2n are described. In addition, in the item of the key input task discriminator 18E, a task that belongs to one of the function task groups 21, . . . , and 2n to be specified by the group discriminator 18B and demands a key input resource that is input from the input apparatus 16 is described, and in the item of the display output task discriminator 18F, a task that belongs to one of the function task groups 21, . . . , and 2n to be specified by the group discriminator 18B and demands a display output resource that is output to the display unit 15 is described.

In addition, in the item of the voice output task discriminator 18G, a task that belongs to one of the function task groups 21, . . . , and 2n to be specified by the group discriminator 18B and demands a voice output resource that is output to the speaker 14A is described; in the item of the back light control 18H, a control method of a back light lighting resource of the display unit 15 to turn on and off the back light is described; and in the item of the incoming interruption operation 18I of calling at a designated time (hereinafter, merely referred to as an alarm), the operation when the alarm interruption is caused during execution of the task belonging to one function task group to be discriminated by the group discriminator 18B is described.

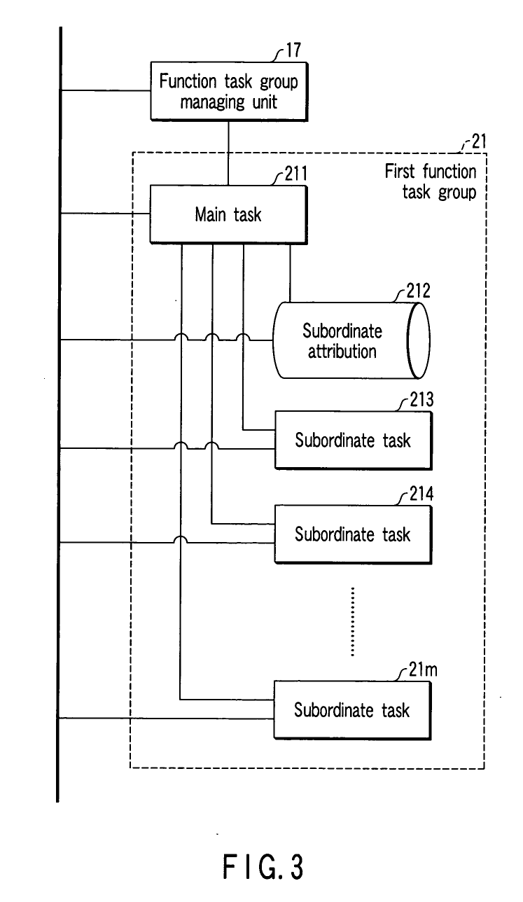

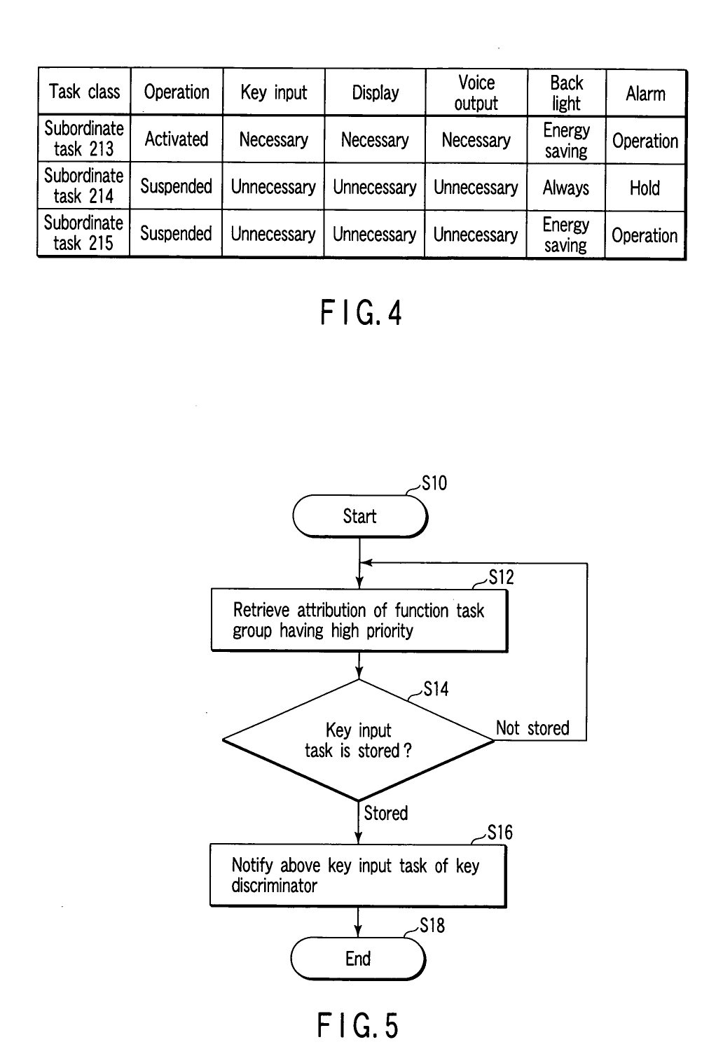

FIG. 3 shows a configuration of the first function task group 21. The first function task group 21 is configured by a main task 211 to be managed by the function task group managing unit 17, a subordinate task attribution 212, a subordinate task 213, a subordinate task 214, . . . , and a subordinate task 21m. In this case, m means an integer number not less than 0. In the subordinate task attribution 212, the discrimination information of the subordinate task 213, a subordinate task 214, . . . , and the subordinate task 21m are stored. As shown in FIG. 4, in the subordinate task attribution 212, the discriminators of the subordinate task 213, the subordinate task 214, and the subordinate task 21m are described, and with related to these discriminators, the items such as the operation of the subordinate task, the key input, the voice output, the back light and the alarm are described. In the item of the operation of the subordinate task, the operation or the interruption is described; in the item of the key input, whether or not the key input is necessary is described; and in the item of the display, whether or not the display is necessary is described. In addition, in the item of the voice input, as same as the above, whether or not the voice output is necessary is described; in the item of the back light, the back light display for an energy saving or “always” for continuing a normal display is described; and in the item of the alarm, if the alarm is activated or if the alarm is suspended is described.

In addition, each of the second to nth function task groups 22 to 2n has the same configuration as that of the first task group shown in FIG. 3, and the nth function task group 2n is configured by a main task 2n1, a subordinate task attribution 2n2, a subordinate task 2n3, a subordinate task 2n4, . . . , and a subordinate task 2np. In this case, n is an integer number not less than 1 and p is an integer number not less than 0.

The operation of the mobile communication terminal that is configured as described above will be described again with reference to FIGS. 1 to 3.

The communication unit 12B shown in FIG. 1 outputs a high frequency signal received by the antenna 12A to the transmission/reception unit 13 and transmits a high frequency signal that is output by the transmission/reception unit 13 from the antenna 12A. The transmission/reception unit 13 may amplify a high frequency signal from the communication unit 12B and convert its frequency of this signal, and then, it may demodulate the signal of which frequency is converted. Obtaining a digital voice signal and a control signal from the demodulated signal, this digital voice signal is transmitted to the speaking unit 14C and the control unit 11. In addition, a digital voice signal to be output from the speaking unit 14C and a control signal to be output from the control unit 11 are converted and amplified, and the frequencies thereof are converted to generate a high frequency signal. Then, this high frequency signal is transmitted to the communication unit 12B.

Upon using the speaking unit 14C, the function task group managing unit 17 may assign the main tasks 211 to 2n1 with reference to the attribution 18A of the function task groups. In addition, according to need, the subordinate tasks 213 to 2np are also assigned in the same way and then, according to the assigned tasks, the speaking unit 14C is controlled by the control unit 11. Accordingly, according to the main tasks 211 to 2n1 and/or the subordinate tasks 213 to 2np, a digital voice signal to be output from the transmission/reception unit 13 is converted into an analog voice signal. Then, the analog voice signal is amplified and is transmitted to the speaker 14A to be reproduced there. In addition, an analog voice signal to be output from the microphone 14B is amplified, and this analog voice signal is transferred to the transmission/reception unit 13 after being converted into a digital voice signal to be transmitted form the transmission/reception unit 13.

Upon using the display unit 15, in the same way, the function task group managing unit 17 may assign the main tasks 211 to 2n1 with reference to the attribution 18A of the function task groups. In addition, according to need, the subordinate tasks 213 to 2np are also assigned and then, according to the assigned tasks, the display unit 15 is controlled by the control unit 11 and a character, a numeric, or the image data are displayed on the display unit 15.

The input apparatus 16 has keys including a numeric key for designating a telephone number of a communication party and a plurality of function keys, and by operating the keys, a key input resource is generated. According to this key input resource, the function task group managing unit 17 may assign the main tasks 211 to 2n1 with reference to the attribution 18A of the function task group, and in addition, according to need, the managing unit 17 may assign the subordinate tasks 213 to 2np. As a result, according to the above-described operated key discriminators, the assigned tasks may be executed.

Next, the operation of the function task group managing unit 17 will be described.

At first, the operation that the function task group managing unit 17 newly generates a function task group and vanish it will be described below. Upon request from the control unit 11 or upon request from the main tasks 211 to 2n1, the function task group managing unit 17 may generate a function task group by activating the requested main task.

Upon generating the function task group, the function task group managing unit 17 may store the function task group 21n in which a new series of items that is specified by the group discriminator 18B as shown in FIG. 2 is added to the attribution 18A of the function task group in the storage unit 18. In other words, the group discriminator 18B of the function task group 21n including the information of a new series of items is newly generated and by this group discriminator 18B, a new function task group is discriminated. According to the following description, the newly generated function task group is defined as the nth function task group 2n to execute the nth function.

In the priority 18C of the new function task group 2n, the information representing the priority of the newly generated nth function task group 2n is stored. In the meantime, the newly generated function task group 2n always has a higher priority than the proprieties of other function task groups. Accordingly, in the priorities 18C of the new function task group 2n, “1” is stored and in the priorities 18C of other function task groups, a value that “1” is added to the value that is stored before generation of the new function task group 2n is stored. In addition, in the main task discriminator 18D of the function task group attribution 18A, the discriminator of the main task of the activated nth function task group 2n is stored.

In addition, in the key input task discriminator 18E of the new function task group 2n, the display output task discriminator 18F, the voice output task discriminator 18G, the back light control 18H, and the incoming interruption operation 18I, the information that is designated from the task to be discriminated by the main task discriminator 18D is stored, and the information that is designated to be changed from the task to be discriminated by the main task discriminator 18D is updated and stored.

In the key input task discriminator 18E, the discrimination information of the main task 2n1 belonging to the nth function task group 2n or the subordinate task 2n3 to 2np, namely, the discrimination information of the task assigned according to the key input resource of the input apparatus 16 is stored. When there is no task assigned according to the key input resource of the input apparatus 16, the information of “no requested task” is stored in the key input task discriminator 18E.

In the display output task discriminator 18F, the discrimination information of the main task 2n1 belonging to the nth function task group 2n or the subordinate task 2n3 to 2np, namely, the discrimination information of the task assigned according to the display resource to the display unit 15 is stored. When there is no task assigned according to the display resource to the display unit 15, the information of “no requested task” is stored in the display output task discriminator 18F.

In the voice output task discriminator 18G, the discrimination information of the main task 2n1 belonging to the nth function task group 2n or the subordinate task 2n3 to 2np, namely, the discrimination information of the task assigned according to the voice output resource to the speaker 14A is stored. When there is no task assigned according to the voice output resource to the speaker 14A, the information of “no requested task” is stored in the voice output task discriminator 18F.

In the back light control 18H, the discrimination information of the main task 2n1 belonging to the nth function task group 2n or a control method of the back light of the display unit 15 during execution of the subordinate tasks 2n3 to 2np is stored. The control method of the back light relates to any of “always lighting”, “energy saving”, and “same as a second priority task group”. The “always lightning” is the control method to always light the back light. The “energy saving” is the control method to turn off the back light when there is no key input from the input apparatus 16 during a predetermined time or subtly light up the back light. In addition, in the case of the “same as a second priority task group” is the control method that is stored in the back light control 18H of a qth function task group 2q that is second high to the priority 18C of this nth function task group 2n is employed.

In the alarm interruption operation 18I, the main task 2n1 belonging to the nth function task group 2n or the operation when the incoming interruption is caused during execution of the subordinate tasks 2n3 to 2np is stored. The operation is any one of “operation” and “hold”, and the operation information of “operation” and “hold” are stored in the alarm interruption operation 18I. The “operation” means the operation to allow generation of a new function task group corresponding to the alarm and the managing unit 17 directly corresponds to the operation generated by the new function task group.

In addition, the “hold” corresponds to the operation that successively continues the operation of the nth function task group 2n and does not allow generation of a new function task group corresponding to the alarm. The new function task group corresponding to the alarm is generated by the function task group managing unit 17 by changing the attribution information 18 owned by the function task group managing unit 17 due to vanish of the nth function task group 2n.

The function task group managing unit 17 vanishes the subordinate tasks 2n3 to 2np belonging to the main task 2n1 due to a vanish request to designate the main task 2n1 from the control unit 11 or by the vanish request from the main task 2n1 of the nth function task group 2n, and then further vanishes the nth function task group 2n by vanishing the main task 2n1. Upon this vanish, a series of item information in which the attribution of the nth function task group 2n is stored is deleted from the attribution 18A of the function task groups. After this deletion, “1” is stored in the priority 18C of the function task group of the highest priority, and as a priority is lower, a series of larger natural numbers is stored in the priority 18C of other function task groups. For example, in the priority 18C of the other function task groups, after deletion of the function task group 2n, a value that “1” is subtracted from the stored value is stored.

Consequently, as described in detail later, when there is an alarm interruption that is held upon vanish of the above-described nth function task group 2n, the function task group managing unit 17 may perform the processing corresponding to the alarm interruption or may continue holding. In other words, after deleting a series of item information in which the discrimination information of the above-described vanished nth function task group 2n is stored, according to the alarm interruption operation 18I of the function task group of the highest priority 18C, the function task group managing unit 17 may perform the processing corresponding to the alarm interruption or may continue holding.

The attribution 18A of the function task group shown in FIG. 2 is an example of the attribution 18A of the function task group when the first to fourth function task groups 21 to 24 are generated. In other words, in the attribution 18A of the function task group, four sets of information are stored, and each of them corresponds to the attributions of the first to fourth function task groups 21 to 24. Then, in the group discriminator 18B of the function task groups, the discriminators of the first to fourth function task groups 21 to 24 are stored.

In this case, it is stored that the first to fourth function task groups 21 to 24 are generated in this order, the priority 18C is the lowest in the first function task group 21, then, the priority 18C is heightened sequentially, and the priority 18C becomes the highest in the fourth function task group 24.

For example, the first function task group 21 is a function task group to execute a waiting function, and in the main task discriminator 18D, the discrimination information of the main task 211 is stored; in the key input task discriminator 18E, the discrimination information of a subordinate task 21x is stored; in the display output task discriminator 18F, the discrimination information of a subordinate task 21y is stored; in the voice output task discriminator 18G, the discrimination information of a subordinate task 21z is stored; in the back light control 18H, the information of “energy saving” is stored, and in the alarm interruption operation 18I, the information of “alarm operation” is stored.

For example, the second function task group 22 is a function task group to execute an e-mail function, and in the main task discriminator 18D, the discrimination information of the main task 221 is stored; in the key input task discriminator 18E, the discrimination information of a subordinate task 22x is stored; in the display output task discriminator 18F, the discrimination information of a subordinate task 22y is stored; in the voice output task discriminator 18G, the discrimination information of a subordinate task 22z is stored; in the back light control 18H, the information of “energy saving” is stored, and in the alarm interruption operation 18I, the information of “hold” is stored.

The main task 221 of the second function task group 22 may store the information of “hold” in the alarm interruption operation 18I via the function task group managing unit 17 during operation of the subordinate task to execute the transmission/reception operation of the e-mail. For example, during operation of the subordinate task to execute an editor creating the text of the e-mail, the information of “alarm operation” is stored in the alarm interruption operation 18I.

The third function task group 23 is a function task group to execute a Web browser function, and in the main task discriminator 18D, the discrimination information of the main task 231 is stored; in the key input task discriminator 18E, the discrimination information of a subordinate task 23x is stored; in the display output task discriminator 18F, the discrimination information of a subordinate task 23y is stored; in the voice output task discriminator 18G, the discrimination information of a subordinate task 23z is stored; in the back light control 18H, the information of “always lighting” is stored, and in the alarm interruption operation 18I, the information of “alarm operation” is stored.

The main task 231 of the third function task group 23 may store the information of “always lighting” in the back light control 18H via the function task group managing unit 17 during operation of the subordinate task to execute the interactive game. For example, during operation of the subordinate task to download the information, the information of “energy saving” is stored in the back light control 18H.

For example, the fourth function task group 24 is a function task group, which is activated when an electric energy that is accumulated in the secondary battery of the movable communication terminal (not shown) becomes a predetermined value and under or at a predetermined time, and the fourth function task group 24 may display and output the electric energy; and then, vanishes after laps of a predetermined time since the fourth function task group 24 is activated. However, the fourth function task group 24 is not limited to this and the fourth function task group 24 may be activated by notice of predetermined key operation of the input apparatus 16. In addition, the fourth function task group 24 may be provided with a function to display the state of the apparatus other than the electric energy and the state of strength of the high frequency signal or the like that is received by the antenna 12A.

In the main task discriminator 18D of the fourth function task group 24, the discrimination information of the main task 241 is stored; in the key input task discriminator 18E, the information of “no required task” is stored; in the display output task discriminator 18F, the discrimination information of the subordinate task 24y is stored; in the voice output task discriminator 18G, the information of “no required task” is stored; in the back light control 18H, the information of “same as a second priority task group” is stored; and in the incoming interruption operation 18I, the information of “same as a second priority task group” is stored.

Next, the operation to assign the key input resources to the function task group managing unit 17 will be described below. FIG. 5 is a flowchart of the operation in the managing unit 17 with related to the function task group when the key input resource is generated from the input apparatus 16. The function task group managing unit 17 may start the operation using the discrimination of the key that is operated as an argument when the key input resource is generated from the input apparatus 16 (step S10).

The function task group managing unit 17 may retrieve the attribution information of the function task group having the highest priority 18C from among the attributions 18A of the function task groups 21 to 2n (step S12), and then, the function task group managing unit 17 may check if the discriminator of the task of the key input task discriminator 18E is stored in the key input task discriminator 18E of that attribution information (step S14). Then, when the discriminator of the above task is stored therein, noticing the discriminator of the key that is operated by the task that is discriminated by that discriminator (step S16), the operation is terminated (step S18). In the meantime, the time when the operation is terminated is stored in a predetermined storage unit within the function task group managing unit 17 as a time when the key input resource is generated from the input apparatus 16.

When the discriminator of the task corresponding to the key input task discriminator 18E is not stored in step S14, the function task group managing unit 17 may return to step S12 because the designated key input task is not stored in the key input task discriminator 18E. In step S12, the attribution information of the function task group having the highest priority 18C is retrieved from among other function task groups with the exception of the function task group of which discriminator of the corresponding task is not stored in the key input task discriminator 18E. In other words, in order to retrieve the key input task discriminator 18E of the function task group in which the discriminator of the task is stored, the operations of step S12 and step S14 are repeated. If the discriminator of the task is not stored in the key input task discriminators 18E of all function task groups in this retrieving, the discriminator of the operated key is discarded.

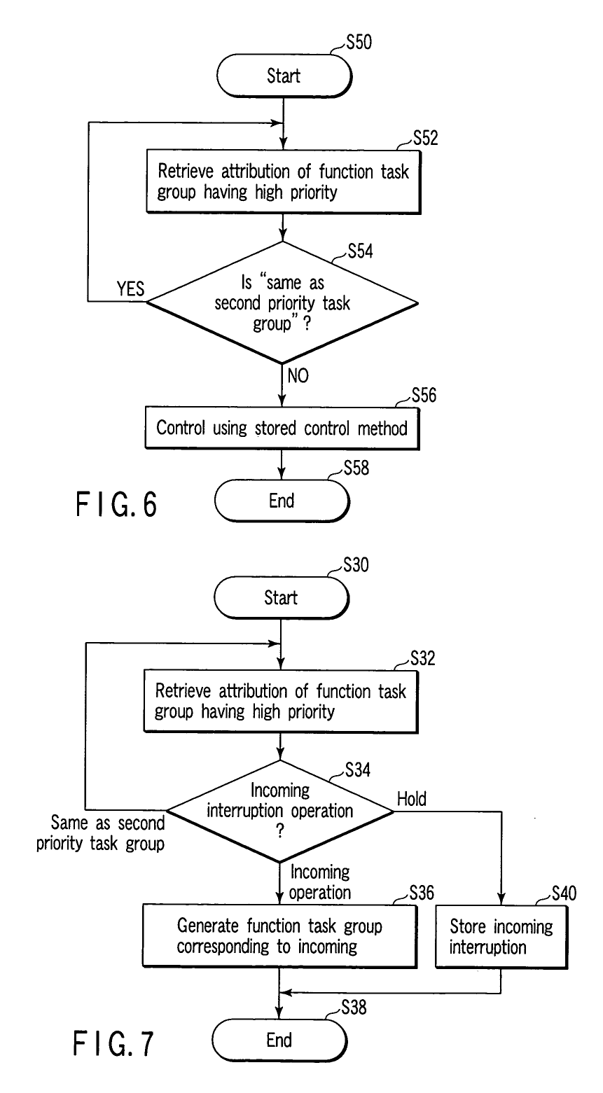

Next, the operation of the back light control in the function task group managing unit 17 will be described below. FIG. 6 is a flowchart showing the operation of the back light control in the function task group managing unit 17. As shown in FIG. 6, the function task group managing unit 17 may be activated by the control unit 11 at predetermined time intervals and may start the operation (step S50).

The function task group managing unit 17 retrieves the attribution information of the function task group having the highest priority 18C from among the attributions 18A of the function task groups (step S52), and it checks if the information of “same as a second priority task group” is stored in the back light control 18H (step S54). Then, if the information of “same as a second priority task group” is not stored therein (“NO” in step S54), according to the control method that is stored in the back light control 18H, the function task group managing unit 17 may control the back light (step S56) to terminate the operation (step S58).

In other words, if the information of “always lighting” is stored in the back light control 18H, the function task group managing unit 17 may light the back light of the display unit 15. In addition, if the information of “energy saving” is stored therein, when a predetermined time lapses from a time when the key input resource is generated from the input apparatus 16 that is stored in a predetermined storage unit within the function task group managing unit 17, the function task group managing unit 17 may turn off the back light or subtly light it, and if the predetermined time does not lapse, the function task group managing unit 17 may light the back light.

In step S54, when the information of “same as a second priority task group” is stored in the back light control 18H (“YES” in step S54), the function task group managing unit 17 may return to step S54, and with the exception of the function task group in which the information of “same as a second priority task group” is stored in the back light control 18H, the function task group managing unit 17 may retrieve the attribution information of the function task group of the highest priority 18C from among other function task groups and may repeat the operations of step S54 and step S56.

As described above, the later generated function task group has the higher priority 18C, and due to the above-described retrieving, it is possible to succeed the information that is stored in the back light control 18H of the function task group that is generated just before the above-described function task group having the highest priority 18C, for example, the information that is stored in the back light control 18H of the function task group that generated the above-described function task group having the highest priority 18C.

When the information of “same as a second priority task group” is stored in the back light control 18H of the all function task groups, according to a predetermined implicit value, and according to the stored information of “always lighting”, or the information of “energy saving”, the operation is performed. In addition, when the back light control 18H is changed from “always lighting” into “energy saving”, the operation same as the key input is carried out, and when a predetermined time lapses, the back light is turned off.

Next, the operation of the function task group managing unit 17 when the alarm interruption is caused will be described below. FIG. 7 is a flowchart showing the operation of the function task group managing unit 17 when the incoming interruption is caused. The function task group managing unit 17 may start the operation when the alarm interruption is caused (step S30).

The function task group managing unit 17 may retrieve the attribution information of the function task group having the highest priority 18C (step S32) from the attribution 18A of the function task group and may check the information that is stored in the incoming interruption operation 18I of that attribution information (step S34). When that information is “incoming operation”, a new function task group 2n corresponding to the alarm is generated (step S36) and the operation is terminated (step S17y).

In addition, when that information is “hold”, the function task group managing unit 17 may store the alarm interruption information in a predetermined storage unit within the function task group managing unit 17 (step S40) and the operation is terminated (step S17y). In addition, when that information is “same as a second priority task group”, the operation returns to step S32. Then, the attribution information of the function task group having the highest priority 18C from among other function task groups with exception of the function task group in which the information of “same as a second priority task group” is stored in the alarm interruption operation 18I, and the operation on and after step S34 is repeated.

When the information of “same as a second priority task group” is stored in the alarm interruption operation 18I of all function task groups, the function task group managing unit 17 makes the operation when the information of “alarm operation” is stored to be performed.

Next, taking the first function task group 21 as an example, the operation of the function task group will be described below.

The main task 211 is a task to oversee the function to be processed by the first function task group 21 and the main task 211 is activated by the function task group managing unit 17 to start the operation of the main task 211. At first, the function task group managing unit 17 may check if the operation of the main task 211 is allowed in the first function task group 21. For example, the main task 211 may notify the function task group managing unit 17 of a result of the check if there are predetermined function task groups that are not allowed to be at the same time, and the function task group managing unit 17 may check if the operation of the main task 211 is allowed in the first function task group 21.

When the operation of the main task 211 is not allowed in the first function task group 21, the main task 211 may immediately vanish its own task. If the operation of the main task 211 is allowed in the first function task group 21, the main task 211 may notify the function task group managing unit 17 of the attribution of the first function task group 21.

Receiving notice of the predetermined key operation from the input apparatus 16, or according to a predetermined processing procedure, the main task 211 may generate the subordinate tasks 213 to 21m and may store the discriminators of the generated subordinate tasks 213 to 21m in the subordinate task attribution 212. In addition, receiving notice of the predetermined key operation from the input apparatus 16, or according to a predetermined processing procedure, the main task 211 may require generation of the new function task group from the function task group managing unit 17. In addition, the main task 211 may notify the function task group managing unit 17 of update of the attribution of the first function task group 21.

In addition, receiving notice of the predetermined key operation from the input apparatus 16, or according to a predetermined processing procedure, or according to an instruction of the function task group managing unit 17, with reference to the subordinate task attribution 212, the main task 211 may vanish all of the subordinate tasks 213 to 21m, may notify the function task group managing unit 17 of an instruction to vanish the first function task group 21 and further, may vanish its own task.

Next, the operation of the subordinate tasks 213 to 21m will be described. Being activated by the main task 211, the subordinate tasks 213 to 21m may start the operation. Then, receiving notice of the predetermined key operation from the input apparatus 16, or according to a predetermined processing procedure, the subordinate tasks 213 to 21m may require generation of the subordinate tasks 213 to 21m from the main task 211, or may require generation of the new function task group via the main task 211 from the function task group managing unit 17.

In addition, receiving notice of the predetermined key operation from the input apparatus 16, or according to a predetermined processing procedure, or according to an instruction of the main task 211, the subordinate tasks 213 to 21m may notify the main task 211 of an instruction to vanish its own task and may vanish its own task.

According to the above description, the function task group managing unit 17 assigns the entire display screen of the display unit 15 to one task as one resource, however, the present invention is not limited to this. For example, the function task group managing unit 17 may assign a rectangular partial screen that is apart of the entire display screen to one task as one resource. When the partial screen is assigned to the task that is discriminated by the display output task discriminator 18F of the function task group having the highest priority 18C, the screen other than the partial screen of the display unit 15 is assigned to the task that is discriminated by the display output task discriminator 18F of the function task group with exception of the function task group having the highest priority 18C.

As described above, according to the present invention, when one function is executed by a plurality of tasks, it is possible to provide a method for managing a task while storing an attribute that is peculiar to a function for each function and an information processing apparatus for managing a task. Accordingly, it is not necessary to store the attribution that is peculiar to the function as the attribution of a plurality of tasks and this makes a complicated task management unnecessary.

In the above description, taking a manner that is adapted to the movable communication terminal as an example, however, it is a matter of course that the present invention can be adapted to all information processing apparatuses to realize one function by a plurality of tasks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for managing a task when a desirable function is executed by one or plural tasks, the method comprising:
configuring a task group of one main task and one or more subordinate tasks instructed to be activated by the main task when a plurality of tasks is activated for executing a desirable function;
assigning priority information to the task or the main task activated according to the function instructed to be executed;
setting an authority of execution to the task or the main task to which the highest priority information is assigned; and
setting the authority of execution to the task or the main task to which a second highest priority information is assigned if the task or the main task to which the authority of execution is set is terminated.

2. The method for managing a task according to claim 1, wherein a task activated for executing the desirable function registers a status whether or not an interruption caused during execution is allowed, and if the interruption is caused, with reference to the status registered in relation to the task set to be active, the task executes the processing with related to the interruption when the interruption is allowed.

3. The method for managing a task according to claim 1, wherein the task activated for executing the desired function registers a status whether or not a resource is required, and assigns the resource to the task to which the highest priority information requiring the resource is assigned.

4. The method for managing a task according to claim 3, wherein, when the status requiring the resource is not registered in the task to which the highest priority information is assigned, the resource is assigned to a task to which the second highest priority information and which requires the resource.

5. An information processing apparatus, comprising:
a task attribution storage unit which is activated to execute a desired function and stores an attribution including priority information assigned to a task group made of a main task and a subordinate task activated by the main task; and
a task control unit which sets an authorization of execution to a task group to which the highest priority information is assigned with reference to the priority information stored in the task attribution storage unit.

6. The information processing apparatus according to claim 5, wherein the attribution stored in the task attribution storage unit includes a step whether or not the interruption is further allowed; and
the task control unit determines whether or not the task control unit executes the interruption with reference to the status stored in relation to the task group to which the authorization of execution is set.
